(19) United States
(12) Patent Application Publication
(10) Pub. No.: US 2026/0244442 A1
(43) Pub. Date: Aug. 20, 2026

(54) EXTENSIBLE DATA FORMAT CONVERSION TECHNIQUES

(71) Applicants: ADVANCED MICRO DEVICES, INC., Santa Clara, CA (US); Xilinx, Inc., San Jose, CA (US)

(72) Inventors: Stuart David Simpson Biles, Bury St. Edmunds (GB); Eric Ford Dellinger, Longmont, CO (US); Michael Estlick, Ft. Collins, CO (US); Brian William Thompto, Austin, TX (US)

(21) Appl. No.: 19/055,393

(22) Filed: Feb. 17, 2025

(51) Int. Cl. G06F 9/30

(52) U.S. Cl. CPC G06F 9/30025; G06F 9/30032; G06F 9/30036

(57) ABSTRACT

A processing system includes a processor to access an input data array in an initial format from a memory and convert the input data array into an output data array in a target format based on an instruction specifying an element size in the input data array. The converting includes unpacking data of the input data array based on the element size to generate unpacked data and employing a look up table (LUT) and the unpacked data to convert to the output data array in the target format. The processor also includes a plurality of compute units to execute operations of an artificial intelligence (AI) model with the output data array.

### BACKGROUND

Processing systems executing Artificial Intelligence (AI) models, such as machine learning (ML) models, use large amounts of data in vectors, matrices, and tensors (collectively herein referred to as “data arrays”). These data arrays can be the input or output of the AI model, the model weights, the activations, or other data used by the AI model. To execute AI models, a processing system receives a data array (e.g., retrieves the data array from a memory), and, in some cases, converts the data array into a target data format type that is compatible with downstream hardware (e.g., matrix multipliers or adders in compute units of the processing system). Once converted, the data array is represented and processed in the target data format type.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of a processing system configured to employ data format conversion techniques in accordance with some embodiments.

FIG. 2 shows an example of conversion circuitry employing a data format conversion technique based on an instruction that specifies an element size in an input data array and at least one look up table (LUT) in accordance with some embodiments.

FIG. 3 shows an example of conversion circuitry employing another data conversion technique based on an instruction that creates a vector of indices based on a specified element size in an input data array in accordance with some embodiments.

FIG. 4 shows an example of a flowchart illustrating an embodiment of a data conversion technique in accordance with some embodiments.

FIG. 5 shows an example of a flowchart illustrating another embodiment of a data conversion technique in accordance with some embodiments.

### DETAILED DESCRIPTION

In some cases, it is beneficial to convert the data format of a data array retrieved from a memory (or received from another processing component) to a different data format to improve AI model processing performance. For example, processing systems may store data arrays in a memory in a compressed data format to conserve memory and to reduce bandwidth demands for transmitting the data arrays from the memory to the processor executing the AI model, and the processor executing the AI model may support a different data format that increases the precision of the computations to improve the quality of the AI model output. Additionally, the processor generally only supports native data formats that it was designed to operate on, so it may be necessary to convert from new/emerging data formats to the ones that the processor supports. Therefore, some processing systems employ processors and instruction sets to facilitate the conversion of data between different data formats depending on the use case.

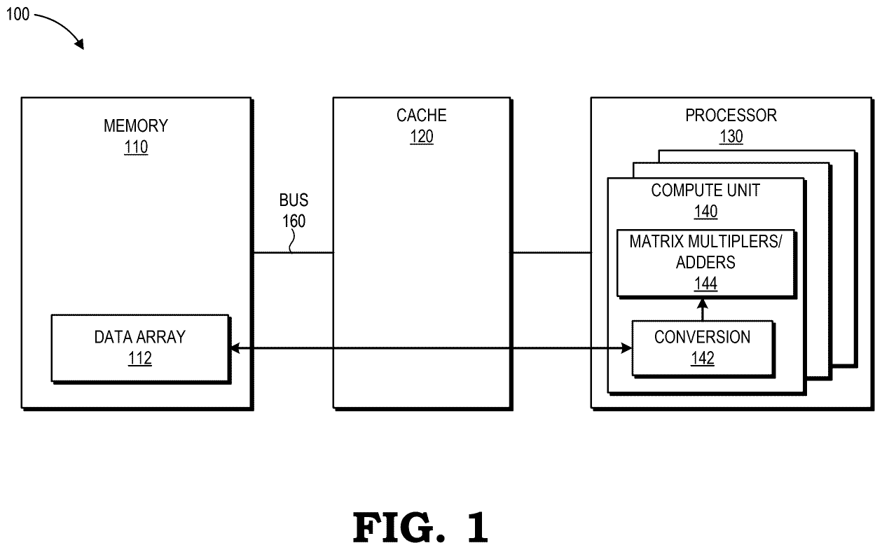

Advanced Vector Extensions (AVX), which is an extension to the x86 instruction set architecture (ISA), is a set of instructions that seek to accelerate data intensive applications, including AI and ML tasks. In some cases, AVX instruction sets are used to convert data between different data formats to improve the performance of executing AI models. For example, a processing system can employ an AVX instruction set to convert data between a reduced precision Open Compute Project (OCP) data format (e.g., 4-bit floating point (FP4), 6-bit floating point (FP6), and 8-bit floating point (FP8) data formats) and higher precision data formats, such as single-precision floating-point format (FP32), half-precision floating-point format (FP16), and BFloat16 (BF16), that are natively supported by a processor in the processing system. The data conversions, in some cases, facilitate the incorporation of an FP8 dot product into an AI framework and provide a degree of future adaptability through expanding FP4 and FP6 data formats into FP8 data formats (or other data formats such as FP16 or BF16). The techniques described in FIGS. 1-5 provide flexible and adaptable data conversion architectures that enable processing systems to support in-line data format conversion to feed computation for devices operating on evolving or programmed defined formats.

To illustrate, in some embodiments, a processing system includes a processor with a plurality of compute units to perform operations for executing, for example, an AI model and a memory to store data arrays for executing the AI model. The memory may store the data arrays in an initial format such as a reduced bit data format (e.g., FP4 or FP6). In some cases, the initial format may be a data format type that either is not supported by the compute units to execute the AI model or reduces the accuracy of the compute units when executing the AI model. As such, the processor includes conversion circuitry to convert the input data array in the initial format to an output data array in a target data format that improves the processing system performance. In some cases, to perform the conversion, the conversion circuitry executes an instruction that specifies a first element size of the data in the input data array. In addition, the conversion circuitry unpacks data of the input data array based on the first element size to generate unpacked data of a second element size (which may be implicit in the instruction or an argument to the instruction) and employs a look up table (LUT) along with the unpacked data to perform the conversion to the output data array in the target format. In some cases, the LUT is programmable, or in other cases, the LUT has fixed contents. The LUT is also specified in the instruction specifying the element size. In other cases, rather than employing a LUT, the conversion circuitry employs a sign/zero extension for expanding narrower integer data types to wider ones. In any case, after generating the output data array in the target data format, the conversion circuitry provides the output data array to the plurality of compute units to perform operations associated with executing the AI model. For example, in some aspects, the plurality of compute units include matrix computation units (e.g., multipliers and/or adders) that use the output data array to perform inferencing operations, convolution operations, linear regression operations, operations to update weights or activation functions during training, or other operations associated with executing the AI model.

One instruction class of the AVX instruction set that may be used for data unpack and LUT functionality is referred to as the permutexvar instruction class. The permutexvar instruction class provides generic lane based permutation functionality, with between 2 and 3 source operands and one output operand. The permutation function is defined by the contents of one source operand and is applied to the data presented in the other source operand(s) in order to generate the desired output. The permutexvar instruction class is flexible and can be used by software to provide a number of useful functions. For example, one function is to unpack data and place the unpacked data into different x-width bit lanes, where x is a positive integer. Another function is to perform LUT operations after the unpacked data in the lanes have been shifted to the appropriate position within the lanes. In the context of using the AVX instruction set for the purposes of data format conversion prior to consumption by an arithmetic unit (such as a fused multiply-add unit, or FMA unit for short) a typical software algorithm might require two separate permutexvar instructions, a shift operation, and masking to correctly condition unpacked data. This potentially introduces a bandwidth mismatch between converting data and consuming the data in the FMA unit.

The embodiments presented herein provide a variation of the permutexvar instruction (referred to as a “permutexvar_unpacked” instruction) and an index generation instruction (referred to as a “genindex” instruction or a “VUNPACK” instruction) that introduce techniques to implement data unpack and LUT functionality in a more compact manner. For example, compared to conventional permutexvar instruction implementations, the techniques described herein occupy fewer (e.g., one or two) issue slots by specifying the packed data element size from the input data array in the initial instruction. This streamlines the data format conversion process, which improves the performance of the processing system when executing a corresponding AI model.

In some embodiments, any of the elements, components, or blocks shown in the ensuing figures are implemented as one of software executing on a processor, hardware that is hard-wired (e.g., circuitry) to perform the various operations described herein, or a combination thereof. For example, one or more of the described blocks or components (e.g., the components of the conversion circuitry associated with the techniques described herein) represent software instructions that are executed by hardware such as a digital signal processor (DSP), an application-specific integrated circuit (ASIC), a set of logic gates, a field programmable gate array (FPGA), a programmable logic device (PLD), a hardware accelerator, a graphics processing unit (GPU), a neural network (NN) accelerator, an artificial intelligence (AI) accelerator, another type of parallel processor, or other type of hardcoded or programmable circuit.

FIG. 1 shows an example of a processing system 100 including a memory 110 and processor 130 including one or more compute units 140 with conversion circuitry 142 that provides a flexible and adaptable data conversion architecture to enable the processing system 100 to support converting input data arrays to output data arrays in various AI data formats, in accordance with some embodiments. While the embodiments herein are discussed in the context of an AI or ML processing system, they are not limited to such. That is, in other embodiments, the techniques described herein are used in other applications that involve converting between different data formats.

For ML applications, large amounts of data such as weight tensors, activations, input/output, and the like are frequently moved from the memory 110 or the cache 120 to the compute units 140 that perform ML operations such as matrix multiplications, matrix additions, or other ML operations. In some cases, the memory 110 is a main memory (e.g., RAM) and, in other cases, the memory 110 includes storage (e.g., solid state drives or hard disk drives). In some embodiments, the memory 110 is coupled to a cache 120 via a bus 160. The bus 160 also couples the cache to the processor 130. In various embodiments, the cache 120 includes any number of cache levels (e.g., L2/L3 cache). In some embodiments, the data array 112 is stored in the memory 110 or in the cache 120 in a compressed data format to conserve memory or to reduce bandwidth demands for transmitting the data array 112 to the processor 130 over the bus 160.

The processor 130 includes compute units 140 for performing the ML operations using the data array 112 retrieved from the memory 110. In some cases, the data array 112 is referred to as an input data array and has a first data format that is converted by the processor 130 (e.g., via the conversion circuitry 142 in the one or more compute units 140) to an output data array (not shown) with a target data format to improve the performance of executing the ML operations at the compute units 140. In the illustrated embodiment, the compute units 140 include matrix multipliers/adders 144 (e.g., FMA units) to execute ML operations, but this is only one example of circuitry that may be in the compute units 140.

In some embodiments, the processor 130 is one or more of a central processing unit (CPU), a graphics processing unit (GPU), a field programmable gate array (FPGA), a system on a chip (SoC) that includes an array of artificial intelligence (AI) engines, another type of parallel processor, or the like. For example, the compute units 140 are cores in a CPU, or a workgroup or a processing tile in a parallel processor such as a GPU. In some embodiments, the compute units 140 include vector processors (e.g., single instruction, multiple data (SIMD)) or streaming multiprocessors (SM) and memory (e.g., registers). In some cases, the compute units 140 are assigned to workgroups by a programmer to execute wavefronts. In other examples, one or more compute units 140 may be assigned to a kernel. If the processor 130 is an FPGA, the compute units 140 are formed using programmable logic in contrast to hardened circuitry or hardened logic, for example.

In some embodiments, the processor 130 retrieves the data array 112 from the memory 110 (or in other embodiments, the processor 130 retrieves the data array 112 from the cache 120) in a compressed data format. In some cases, processing the data from the data array 112 in the compressed data format at the compute units 140 may adversely impact the performance of the hardware or the compute units 140 may not natively support the compressed data format. As such, the compute unit 140 may benefit from converting the data array 112 having the compressed data format to an output data array in a target data format that is different than the first data format. For example, in some embodiments, the compressed data format is an FP4 or FP6 data format, and the target data format is an FP8, FP16, or BF16 data format.

In some embodiments, the compute unit 140 includes conversion circuitry 142 to convert the data array 112 (also referred to herein as an “input data array”) having a first data format (or an initial data format) to an output data array having a target data format for processing at the matrix multipliers/adders 144 of the compute unit 140. The conversion circuitry 142 includes hardware, software, or a combination thereof, that is configured to unpack the data of the data array 112 into lanes or indices based on an element size of the data array 112 and perform LUT operations based on the unpacked data to expand the data of the data array 112 into a wider target data format. In some cases, the conversion circuitry 142 performs these operations in fewer cycles for an FMA unit compared to conventional techniques, thus streamlining the data format conversion process and improving the efficiency of executing the AI model at the compute units 140.

While FIG. 1 illustrates using the conversion circuitry 142 when moving data into the compute units 140, this is just one example. In some AI and ML applications, the data formats are evolving toward shorter data format types. The motivation is to perform more operations faster and make more efficient use of the available memory bandwidth and storage capacity. In other cases, while the processing system 100 may not attain peak compute performance when the conversion circuitry 142 converts to a wider data format, the processing system 100 may still benefit from mitigating memory bound scenarios as it is the data in the compressed data format that is broadcast through the memory system 110. As such, the processing system 100 may process and convert data within the processor 130 (e.g., from one compute unit 140 to another one of the compute units 140) or move data from the processor 130 to the memory 110 or the cache 120 using similar conversion techniques as those described herein. In some embodiments, the format conversion techniques described herein are applied in a memory path as part of a function of a cache hierarchy. For example, a memory controller or processor in the memory hierarchy processes and converts data when fetching data in a more compressed format from a lower level of the memory hierarchy and expands data to a wider format for storing in a higher level of the cache hierarchy. As such, the system provides the benefits of maximizing bandwidth efficiency at lower levels of the memory hierarchy, where bandwidth is often constrained.

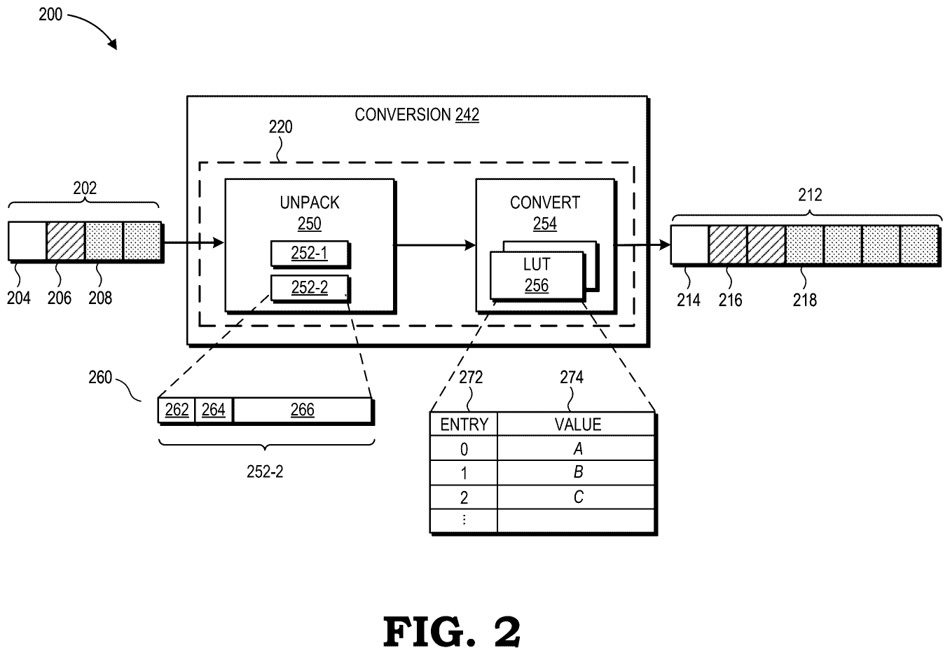

FIG. 2 shows an example diagram 200 of a conversion circuitry 242 converting an input data array 202 having a first format to an output data array 212 having a target data format in accordance with some embodiments. In some embodiments, the conversion circuitry 242 corresponds to the conversion circuitry 142 of FIG. 1. For example, the conversion circuitry 242, in some embodiments, is included in a compute unit of a processor such as in the compute unit 140 of the processor 130 of FIG. 1.

The conversion circuitry 242 accesses the input data array 202 from another component of a processing system that includes the conversion circuitry 242. For instance, referring to FIG. 1 by way of example, the conversion circuitry 242 receives the input data array 202 from the memory 110 or the cache 120 via bus 160. In some embodiments, the conversion circuitry 242 loads the input data array 202 into a register in a register file (e.g., an AVX register file) and unpacks/converts the input data array 202 to the output data array 212 in the target data format in one or more target registers. In some embodiments, the output data array 212 is then used to execute operations associated with an AI model at one or more matric computation units (e.g., at matrix multipliers/adders 144 of FIG. 1). For example, the output data array 212 is used to perform inferencing operations, convolution operations, linear regression operations, operations to update weights or activation functions during AI model training, or other operations associated with executing the AI model.

The input data array 202 is in a first data format and includes a predefined number of bits that are based on the first data format. In the illustrated embodiments, the data value bits are represented by the different shaded boxes. For example, in the illustrated embodiments, the input data array 202 is shown as include one sign bit 204, one exponent bit 206, and a plurality of mantissa bits 208 (only the first mantissa bit is labeled for clarity purposes). In the illustrated embodiments, the number of bits in the plurality of mantissa bits 208 is two, but in other embodiments, the number of bits in the plurality of mantissa bits is another number. In some embodiments, the input data array 202 represents a plurality of values in the first data format, where each value of the plurality of values in the input data array 202 includes a sign bit 204, exponent bit(s) 206, and mantissa bit(s) 208. That is, while the embodiment illustrated in FIG. 2 shows the input data array 202 as an array of bits (with one sign bit 204, one exponent bit 206, and two mantissa bits 208), in other embodiments, the input data array 202 includes multiple such arrays, each having respective sign, exponent, and mantissa bits. That is, in some cases, the input data array 202 includes a plurality of data elements sharing a first data format having the combination of sign, exponent, and mantissa bits. In some cases, the first data format of the input data array 202 is in a compressed data format. Although the embodiments above discuss formal floating point data formats with a fixed sign, exponent, and mantissa bit allocations, in other embodiments, the techniques described herein are similarly applicable to integer formats (e.g., sign plus magnitude or two's complement variants). In addition, in some aspects, the encodings use the combinatorial range of the first data format width to encode a number of possible values in the target data format (e.g., a 4-bit encoding can represent 2⁴=16 discrete values).

The conversion circuitry 242 includes hardware, software, or a combination thereof that executes a permutexvar_unpack or a permutex2var_unpack instruction (collectively referred to as a “permutexvar_unpack” instruction) 220, where the permutexvar_unpack instruction indicates employing one register in the LUT operation and the permutex2var_unpack indicates employing two registers in the LUT operation. In some embodiments, the one or more registers employed in the LUT operation are writeable by software or other means. That is, in some cases, the LUT content is not fixed or hard-coded and may be applied differently to different input operands. The LUT values may be programmed, for example, by loading from memory and then specified (or selected from a set) for each active operand data. The LUT values provide an input to output map for the conversion that are defined by the permutexvar_unpack instruction 220, i.e., the instructions determine the conversion mapping from input to output values for selected sets of operand data. The conversion function encoded in the LUT can be different for different sets of operands, such as specified in the instruction or as labeled for a set of memory inputs in the compute unit. In some embodiments, the conversion circuitry 242 executes the permutexvar_unpack instruction 220 based on a specified first element size of the input data array 202 to generate unpacked data of a second element size (i.e., an output lane size) which is used to convert to an output data array 212 in a target data format. In addition, the conversion circuitry 242 executes the permutexvar_unpack instruction 220 based on the output lane size (which may be implicit in the instruction or an argument of the instruction), where the second element size corresponds to a number of bits for the element size in the output data array 212. To execute the permutexvar_unpack instruction 220, the conversion circuitry 242 includes an unpack component 250 that is configured to read and unpack the elements of the input data array 202 into a plurality of lanes 252 based on the first element size of the data in the input data array 202 and an element size of the output data array 212. In addition, the conversion circuitry 242 includes a convert component 254 that is configured to convert the unpacked elements to the output data array 212 by employing one or more LUTs 256 that include entries corresponding to the unpacked data in the plurality of lanes 252. In some embodiments, in addition to identifying the input data array 202 as a packed vector with data starting at bit 0 (or, in some cases, at an offset starting position, which may be specified in an argument to the permutexvar_unpack instruction), the permutexvar_unpack instruction 220 specifies an element size of the data packed in the input data array 202 and one or more LUTs (e.g., such as one of the LUTs 256) to employ in the conversion process. In some cases, the permutexvar_unpack instruction 220 is a permute and shuffle instruction type that is used to both unpack data and perform LUT operations in a more streamlined manner for an FMA unit.

In some cases, the unpack component 250 is utilized to widen the compressed data in the input data array 202 to a target data format of the output data array 212 by unpacking the compressed data of the input data array 202 into the plurality of lanes 252. The width of the plurality of lanes 252 depends on the target data format of the output data array 212. For example, if the target data format is FP8, then each lane of the plurality of lanes 252 has a width of 8 bits, or if the target data format is FP16 or BF16, then then each lane of the plurality of lanes 252 has a width of 16 bits. In some cases, the width of the plurality of lanes 252 is implicit in the instruction. In other cases, the width is specified as an argument to the instruction. In some cases, the compressed data in the input data array 202 is assumed to be packed with the first element starting at bit 0 of a 512-bit vector. In other cases, the first element may start at an offset bit other than bit 0. For example, the offset bit may be an argument to the instruction and may be further computed from a combination of the input element size, the destination (or target) element size, the vector width, and the start offset indicator. The unpack component 250 reads and unpacks the data in the input data array 202 by placing the bits associated with each element of the input data array 202 into corresponding lanes of the plurality of lanes 252. In some embodiments, the unpack component 250 employs a shuffle input register to perform the necessary bit/element picking for each lane of the plurality of lanes 252. For example, the unpack component 250 unpacks a first data element from the input data array 202 into a first lane 252-1 of the plurality of lanes 252, a second data element from the input data array 202 into a second lane 252-2 of the plurality of lanes 252, and so on. While only two lanes 252-1, 252-2 are shown in the plurality of lanes 252, it is appreciated that this is for clarity purposes and that this number is scalable to other quantities.

After unpacking and placing each element of the input data array 202 into a corresponding lane of the plurality of lanes 252, in some embodiments, the unpack component 250 aligns each unpacked element to one side of the corresponding x-bit lane 252 (where x indicates the number of bits in the target data format). In some cases, the unpack component 250 employs a shift lane register to align each of the elements at the bottom (or the top) of each lane 252 since a different magnitude shift may be needed to shift each element within the lane 252. One example of this is shown in the callout 260 for lane 252-2 where the unpacked data element 266 is shifted to the bottom (or to the right) of the lane 252-2. This shift frees up empty bit slots 262, 264 at one end of the lane 252-2. In some embodiments, the freed up bits are set to a default value, such as “0”, “1”,or copies of the top bit of the shifted unpacked data element. In some embodiments, the conversion circuitry 242 inserts encoding mapping bits in bit slots 262, 264 freed up by shifting the unpacked data element 266 to one side of the lane 252-2 to provide additional encoding information for converting the input data array 202 to the output data array 212. For example, in some embodiments, the encoding mapping bits inserted in bit slots 262, 264 are bits that indicate a codebook for subtitle translation mapping for converting bits in the input data array 202 to bits in the output data array 212.

After unpacking the data into the plurality of lanes 252 with the unpack component 250, the conversion circuitry 242 employs the convert component 254 to finish the conversion of the input data array 202 to the output data array 212. In some embodiments, the convert component 254 is hardware, software, or a combination thereof, that generates the output data array 212 based on the unpacked data in the plurality of lanes 252. For example, in some cases, the convert component 254 is a second part of the permutexvar_unpack instruction 220 in addition to the unpack component 250. In some embodiments, the convert component 254 employs one or more registers associated with one or more LUTs 256 having entries that are associated with each lane of the plurality of lanes 252 and a corresponding x-bit entry in the output data array 212, where x is the number of bits in the target data format (e.g., 8 in an 8-bit target data format or 16 in a 16-bit target data format). For instance, one input to the permutexvar_unpack instruction 220 is a vector treated as lanes of x-bit in width with each lane containing an element of m-bits in width, where m≤x. Each m-bit element is evaluated as an index value that is used to read an entry 272 from the LUT 256. The LUT 256 is formed from one or more vector registers and treated as having a plurality of x-bit wide entries. For example, if a particular m-bit field encodes a “0”, then the 0^{th} entry 272 in the LUT 256 is retrieved and its value 274 (A) is placed in the corresponding output lane for generating the output data array 212. If a particular m-bit field encodes a “1”,then the 1^{st} entry 272 in the LUT is retrieved and its value 274 (B) is placed in the corresponding output lane for the output data array 212, and so on. That is, each of the values contained within each lane of the plurality of lanes 252 is used to look up an entry 272 in the LUT 256 and the entry's value 274 is used for the corresponding output lane of x-bit width in the output data array 212.

In the illustrated embodiment, the output data array 212 is shown as having one sign bit 214, two exponent bits 216 (only the first one labeled for clarity), and four mantissa bits 218 (only the first one labeled for clarity). However, in other embodiments, the number of exponent bits 216 and the mantissa bits 218 are other numbers. Furthermore, in yet other embodiments, the techniques described herein are similarly applicable to other conversions for other data formats such as integer or raw encoded data formats (e.g., sign plus magnitude or two's complement variants) in addition to the floating point data formats discussed herein.

As provided above, in some embodiments, the conversion circuitry 242 performs the conversion of the input data array 202 to the output data array 212 by employing a permutexvar_unpack instruction 220 that specifies the element size of the input data array 202 to be converted. This streamlines the conversion process by reducing the number of processing steps or instructions to perform the conversion compared to conventional methods. By reducing the number of processing steps or instructions to perform the conversion, the techniques described herein reduce or eliminate the likelihood of bandwidth mismatch between converting data and consuming the data in the compute unit.

In some embodiments, the conversion circuitry 242 implements the unpack component 250 and the convert component 254 by employing a class of permutexvar_unpack instructions that include an argument that specifies the packed data size of the data in the input data array 202.

For example, for widening from a compressed data format (e.g., 4-bit or 6-bit data formats) to a 16-bit data format, the conversion circuitry 242 executes a permutex2var_unpack instruction with arguments that specify two registers (e.g., tableA and tableB) for the LUT 256, the input data array 202 in vector format packed starting at an initial bit, and the packed data size of the data in the input data array 202. As another example, for widening from a compressed data format (e.g., 4-bit or 6-bit data formats) to an 8-bit data format, the conversion circuitry 242 executes a permutexvar_unpack instruction with arguments that specify one register (e.g., table) for the LUT 256, the input data array 202 in vector format packed in starting at an initial bit, and the packed data size of the data in the input data array 202.

In some embodiments, the elements of the input data array 202 are packed with the first element starting at a particular bit (e.g., at bit 0 or at another bit depending on a predetermined offset) of a 512-bit vector. Once the elements are extracted from the input data array 202 and unpacked into the x-bit width plurality of lanes 252 (where x indicates the target data format bit width) based on the specified element size, the conversion circuitry 242 reads the values of the unpacked data elements in each corresponding lane of the plurality of lanes 252 to perform a look up operation at a corresponding entry of the LUT 256 to output converted data values for the output data array 212.

In some embodiments, as an example for widening to an output data array 212 with a 16-bit format, the permutexvar_unpack instruction 220 build upon existing AVX-512 instructions and is represented by the following: __m512bh res=_mm512_permutex2var_unpack_epi16 (tableA, vecIn, tableB, size); where tableA and tableB represent respective registers to use for the LUTs 256, vecIn represents the input data array 202 in vector format, and size represents the element size in the input data array 202. In another example, for widening to an output data array 212 with an 8-bit format, the permutexvar_unpack instruction 220 is represented by the following: __m512i res=_mm512_permutexvar_unpack_epi8 (vecIn, table, size); where table represents the register to use for the LUT 256, vecIn represents the input data array 202 in vector format, and size represents the element size in the input data array 202. In some embodiments, the permutexvar_unpack instruction 220 builds upon existing AVX-512 instructions including:
_m512i _mm512_permutex2var_epi16 (__m512i a, __m512i idx, __m512i b) that maps to the instruction VPERMI2W and
__m512i _mm512_permutexvar_epi8 (__m512i idx, __m512i a) that maps to VPERMB.
In other embodiments, the permutexvar_unpack instruction 220 builds upon other varieties of VPERM instructions (e.g., a 1 table variant of the _epi16 class, a 2 table variant of the _epi8 class).

In this manner, the conversion circuitry 242 provides a pipelined implementation to facilitate consecutive issue of successive conversions of the input data array in the compressed format to the output data array in the target format. This creates a more balanced conversion to dot-product flow, thereby improving the performance of a processing system when executing an AI model based on the expanded output data array.

The conventional conversion techniques require additional multiple instruction steps compared to the techniques described herein. For example, for converting from a 6-bit format (e.g., like FP6) to BF16, the conventional conversion technique using the existing AVX-512 ISA is:
__m512i in=_mm512_permutexvar_epi8(shuffle_input, vecIn);
__m512i indices=_mm512_srlv_epi16(in, shift_lanes);
__m512bh res=(__m512bh) _mm512_permutex2var_epi16 (tableA, indices, tableB);

On the other hand, the techniques described herein enable the conversion circuitry 242 to combine the steps performed by the above instructions and additionally derives the necessary shuffling and alignment from the input data format size operand to improve the efficiency of the conversion to the output data array.

While the illustrated embodiment shows the convert component 254 employing one or more LUT(s) 256 for generating the values for inserting into the output data array 212, in other embodiments, the convert component 254 employs an alternative mechanism. For example, in some embodiments, the convert component 254 employs a sign/zero extension component for converting to the output data array 212. In some cases, the sign/zero extension component is used for converting integer data formats.

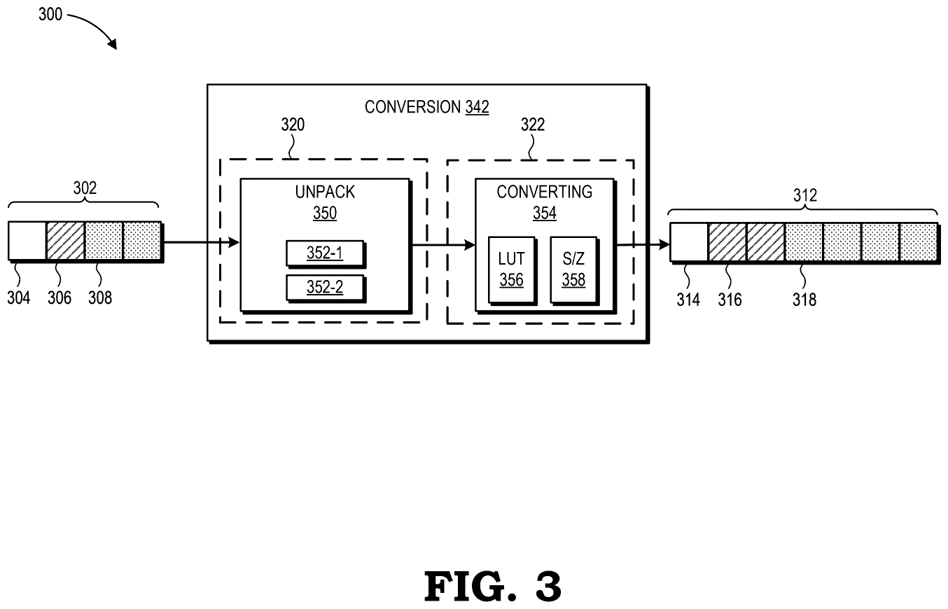

FIG. 3 shows an example diagram 300 of a conversion circuitry 342 converting an input data array 302 having a first format to an output data array 312 having a target data format in accordance with some embodiments. In some embodiments, the conversion circuitry 342 corresponds to the conversion circuitry 142 of FIG. 1. For example, the conversion circuitry 342, in some embodiments, is included in a compute unit of a processor such as in the compute unit 140 of the processor 130 of FIG. 1. In some embodiments, the output data array 312 is then used to execute operations associated with an AI model at one or more matric computation units (e.g., at matrix multipliers/adders 144 of FIG. 1). For example, the output data array 312 is used to perform inferencing operations, convolution operations, linear regression operations, operations to update weights or activation functions during AI model training, or other operations associated with executing the AI model.

The conversion circuitry 342 accesses the input data array 302 from another component of a processing system that includes the conversion circuitry 342. For instance, referring to FIG. 1 by way of example, the conversion circuitry 342 receives the input data array 202 from the memory 110 or the cache 120 via bus 160.

The input data array 302 is in a first data format and includes a predefined number of bits that are based on the first data format. In the illustrated embodiments, the data value bits are represented by the different shaded boxes. For example, in the illustrated embodiments, the input data array 302 is shown as include one sign bit 304, one exponent bit 306, and a plurality of mantissa bits 308 (only the first mantissa bit is labeled for clarity purposes). In the illustrated embodiments, the number of bits in the plurality of mantissa bits 308 is two, but in other embodiments, the number of bits in the plurality of mantissa bits is another number. In some embodiments, the input data array 302 represents a plurality of values in the first data format, where each value of the plurality of values in the input data array 302 includes a sign bit 304, exponent bit(s) 306, and mantissa bit(s) 308. That is, while the embodiment illustrated in FIG. 3 shows the input data array 302 as an array of bits (with one sign bit 304, one exponent bit 306, and two mantissa bits 308), in other embodiments, the input data array 302 includes multiple such arrays, each having respective sign, exponent, and mantissa bits. That is, in some cases, the input data array 302 includes a plurality of data elements sharing a first data format having the combination of sign, exponent, and mantissa bits. In some cases, the first data format of the input data array 302 is in a compressed data format. Although the embodiments above discuss formal floating point data formats with a fixed sign, exponent, and mantissa bit allocations, in other embodiments, the techniques described herein are similarly applicable to integer formats (e.g., sign plus magnitude or two's complement variants). In addition, in some aspects, the encodings use the combinatorial range of the first data format width to encode a number of possible values in the target data format (e.g., a 4-bit encoding can represent 2⁴=16 discrete values).

The conversion circuitry 342 includes hardware, software, or a combination thereof that executes an index generation instruction (referred to herein as a “genindex” or an “VUNPACK” instruction) 320 to create the vector of indices 352 based on a specified element size of the elements in the input data array 302. In some embodiments, the vector of indices 352 is also based on a second element size (e.g., corresponding to the output data array) and/or aligned to the output lane size indicated by the instruction. In some cases, the conversion circuitry 342 also includes hardware, software, or a combination thereof that executes an optional permutexvar instruction 322 to perform a conversion operation based on the generated vector of indices 352. To execute the index generation instruction 320, in some embodiments, the conversion circuitry 342 includes an unpack component 350 that is configured to create a vector of indices 352 and to unpack the elements of the input data array 302 into the vector of indices 352 based on an element size of the data in the input data array 302. To execute the permutexvar instruction 322, the conversion circuitry 342 includes a converting component 354 that is configured to read the unpacked elements in the vector of indices 352 and convert the vector of indices 352 to the output data array 312. For example, in some cases, the converting component utilizes either a LUT 356 or a sign/zero extension (S/Z) component 358 that uses the unpacked data in the vector of indices 352 as an input to generate the output data array 312. For example, if employing the LUT 356, the LUT 356 includes entries corresponding to value of the vector of indices 352 and functions substantially similar to the LUT 256 of FIG. 2 described above. In other embodiments, the converting component 354 employs the sign/zero extension (S/Z) component 358 that replicates the most significant bit (MSB) of the loaded value from the vector of indices 352 into remaining bits of the output data array 312 (i.e., sign extension) and/or fills in the remaining bits with zeroes (i.e., zero extension). In yet other embodiments, the converting component 354 employs a codebook (not shown) to pad the unpacked data with dictionary index data used to select from a number of possible LUT configurations.

In a first aspect, the unpack component 350 generates a vector of indices 352 based on a size of the elements in the input data array 302. In a second aspect, after creating the vector of indices 352, the unpack component 350 unpacks and aligns the data from the input data array 302 into corresponding indices. In some embodiments, the converting component 354 executes the optional permutexvar instruction 322 that receives the values in the vector of indices 352 generated by the unpack component 350 and performs a LUT operation at a LUT 356 to output values to use in the output data array 312 in the target data format. In other embodiments, the converting component 354 executes the optional permutexvar instruction 322 that receives the values in the vector of indices 352 generated by the unpack component 350 and subjects the aligned values in the vector of indices 352 to additional formatting such as sign or zero extension (via the S/Z component 358) or merging with a codebook index value by OR'ing a codebook index into unused bits in the destination lane size.

In the illustrated embodiment, the output data array 312 is shown as having one sign bit 314, two exponent bits 316 (only the first one labeled for clarity), and four mantissa bits 318 (only the first one labeled for clarity). However, in other embodiments, the number of exponent bits 316 and the mantissa bits 318 are other numbers. In yet other embodiments, the techniques described herein are similarly applied to cover arbitrary data conversions such that for an m-bit input data, each unpacked element is used to look up a corresponding x-bit output data element from an entry in the LUT 356.

In some embodiments, the conversion circuitry 342 performs the conversion of the input data array 302 to the output data array 312 by employing instructions to (1) generate a vector of indices 352 based on a specified element size of the input data array 302 in which to unpack the data elements of the input data array 302 and (2) perform a look up operation to find a corresponding entry in the LUT 356 based on the data in the vector of indices 352. This streamlines the conversion process by reducing the number of processing steps or instructions to perform the conversion compared to conventional methods. By reducing the number of processing steps or instructions to perform the conversion, the techniques described herein reduce or eliminate the likelihood of bandwidth mismatch between converting data and consuming the data in the compute unit.

In some embodiments, for widening to an output data array 212 with an 8-bit format, for example, the index generation instruction 320 is represented by the following: __m512i idx=_mm512_genindex_epi8 (vecIn, size); where vecIn represents the input data array 302 in vector format, and size represents the element size in the input data array 302. In other embodiments, for widening to an output data array 212 with an 8-bit format, for example, the index generation instruction 320 is represented by the following: _mm512_unpack_epi8(vecIn, size, start, signext), where vecIn is the input data array 302, size indicates the size of the input data format (e.g., from 2 to 7 bits), start indicates an offset of start*size bits into vecIn from which to start extracting and unpacking element data, and signext is a Boolean that indicates to zero or sign extend the extracted data up to the 8-bit destination lane width. In some cases, the offset (in bits) is equal to size*start*64 bits. That is, for example, for a 512-bit destination vector having 64 8-bit lanes, start indicates how many groups of 64 input elements (of width size) to start unpacking from.

The permutexvar instruction 322 is represented by the following: __m512i res=_mm512_permutexvar_epi8 (idx, table); where idx corresponds to the index (or indices) generated by the index generation instruction 320, and table represents the register to use for the LUT 356.

In this manner, the conversion circuitry 342 provides a pipelined implementation to facilitate consecutive issue of successive conversions of the input data array in the compressed format to the output data array in the target format. This creates a more balanced conversion to dot-product flow, thereby improving the performance of a processing system when executing an AI model based on the expanded output data array.

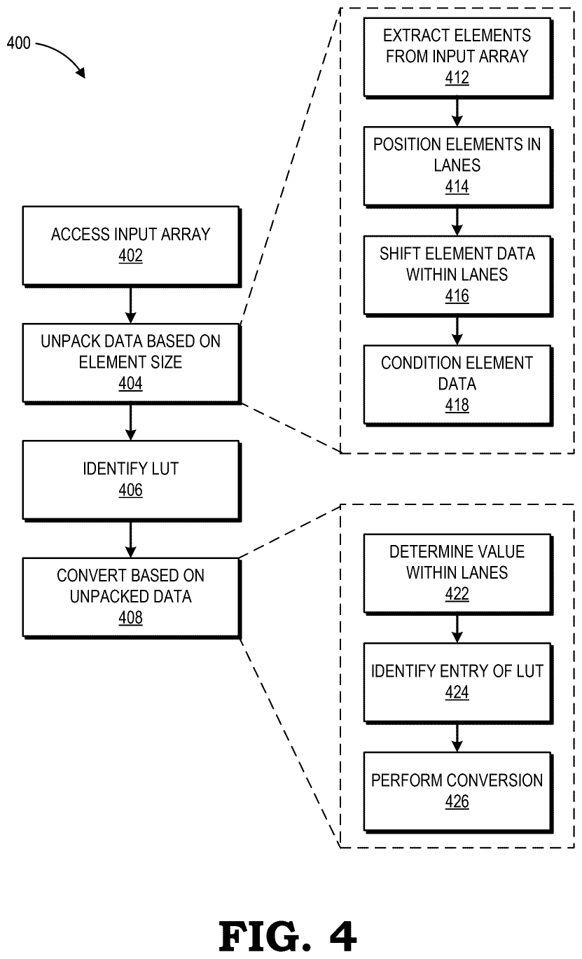

FIG. 4 shows an example of a flowchart 400 illustrating an embodiment of a data conversion method, executed at a processor such as the processor 130 of FIG. 1, in accordance with some embodiments. In some embodiments, the method shown in flowchart 400 is implemented at the conversion circuitry 242 of FIG. 2.

At block 402, the processor receives an input array. For example, in some embodiments, this involves a conversion circuitry (such as the conversion circuitry 242 of FIG. 2) in the processor accessing an input data array (such as the input data array 202 of FIG. 2) in an initial data format from a memory such as memory 110 or cache 120 via a bus such as bus 160. In some cases, the initial data format is a compressed data format such as a 4-bit or 6-bit data format.

At block 404, the processor unpacks the data based on an element size of the data in the input array. For example, in some embodiments, this includes the processor extracting data elements from the input array 412 based on the specified element size and positioning the extracted data elements into a plurality of lanes 414 whose width is the same as the target data format. Additionally, in some embodiments, the processor shifts the unpacked data within the lanes 416 so that the data is at one end of the lanes. Also, in still other embodiments, the processor conditions the element data at block 418. The conditioning steps at block 418 include, for example: sign extend, zero extend, or merge. In some cases, the merge conditioning step includes combining the unpacked data with additional data provided from another source, e.g., codebook index data. The merge operation may be a logical operation or may be combining unpacked data in the lower portion of the unpacked lane and additional data presented in bits of the unpacked lane that are not needed to accommodate the unpacked element data].

At optional block 406, the processor identifies a LUT. For example, in some cases, the LUT table is specified in the same instruction that specifies the element size of the input array. However, if the processor does not employ a LUT (e.g., if the processor instead utilizes a sign and/or zero extend component as described above), the processor may skip block 406 and proceed directly to block 408.

At block 408, the processor converts the unpacked data in the lanes generated at block 404 to the output data array (such as output data array 212 of FIG. 2). If the method includes the processor performing the optional block 406, the processor employs the LUT identified at block 406. For example, in some embodiments, the processor determines a value of each unpacked data element within each one of the plurality of lanes 422 and identifies a corresponding entry in the LUT 424 based on the value. Then, the processor performs the conversion 426 based on the entry in the LUT.

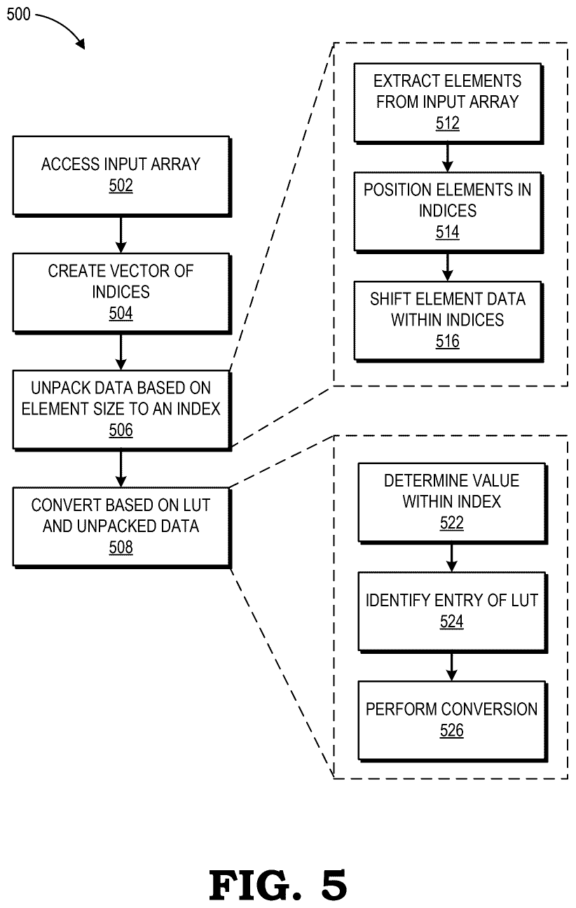

FIG. 5 shows an example of a flowchart 500 illustrating an embodiment of a data conversion method, executed at a processor such as the processor 130 of FIG. 1, in accordance with some embodiments. In some embodiments, the method shown in flowchart 500 is implemented at the conversion circuitry 342 of FIG. 3.

At block 502, the processor receives an input array. For example, in some embodiments, this involves a conversion circuitry (such as the conversion circuitry 342 of FIG. 3) in the processor accessing an input data array (such as the input data array 302 of FIG. 3) in an initial data format from a memory such as memory 110 or cache 120 via a bus such as bus 160. In some cases, the initial data format is a compressed data format such as a 4-bit or 6-bit data format.

At block 504, the processor creates a vector of indices based on a specified element size of the input array received at block 502. For example, in some embodiments, this includes a conversion circuitry (such as the conversion circuitry 342 of FIG. 3) generating a vector of indices such as the vector of indices 352 of FIG. 3.

Then, at block 506, the processor unpacks the data of the input array received at block 502 into the vector of indices generated at block 504. For example, in some embodiments, this includes the processor extracting data elements from the input array 512 and positioning the extracted data elements into an index of the vector of indices 514. Additionally, in some embodiments, the processor shifts the unpacked data within the indices 516 so that the data is at one end of the indices.

At block 508, the processor converts the unpacked data in the vector of indices of block 506 into an output array based on a LUT operation. For example, in some embodiments, the processor identifies a value within each index of the vector of indices 522, identifies a corresponding entry of a LUT 524 based on the value identified at block 522, and then performs the conversion to the output data array in the target data format at block 526.

Thus, in some embodiments, the techniques of the present disclosure enable a flexible, in-line data format conversion to feed computation. The data format conversion is “in-line” as the conversion is performed by the processor after accessing or retrieving the data (in an initial format) from a memory and prior to executing computations based on the converted data in a target format at the processor. As such, the in-line data conversion can be performed in real-time or in a batched process to convert the data in the initial format (which may, for example, be a compressed data format to conserve memory and to reduce bandwidth demands for transmitting the data from the memory to the processor) to data in the target format that is supported by the compute units of the processor. These techniques can be applied to an AI device or any other device operating on evolving or program defined formats. For example, in some embodiments, a software program includes instructions as described herein to activate the conversion circuitry in a CPU or other processing unit to perform the conversion. In other embodiments, the software program includes instructions to activate conversion circuitry to process operand data streaming into a computational engine such as a neural processing unit (NPU), a graphics processing unit (GPU), AI processor, or other parallel processor where the conversion attributes are programmed, and the conversion circuitry is activated for the appropriate data sets dynamically. In other embodiments, the memory system include conversion circuitry to process operand data as it is transferred from one level of a memory hierarchy to another. Whichever the case, the program is provided one or both of an indicator of the packed size of the operation so that it may be unpacked and aligned for native computation in the target engine, and the data mapping to convert between input data, of the specified size, to output data of a specified output size. The data mapping, in some cases, is performed using a LUT which has values (the input to output map) that are defined by the program.

In some embodiments, the apparatus and techniques described above are implemented in a system including one or more integrated circuit (IC) devices (also referred to as integrated circuit packages or microchips), such as the compute unit described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]--is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
accessing, by a parallel processor, an input data array in an initial format from a memory to execute one or more operations associated with an artificial intelligence (AI) model;
converting, at conversion circuitry of the parallel processor, the input data array into an output data array in a target format based on an instruction specifying an element size in the input data array, wherein the converting comprises:
unpacking data of the input data array based on the element size to generate unpacked data; and
converting the unpacked data to the output data array in the target format; and
executing the one or more operations of the AI model with the output data array at the parallel processor.

2. The method of claim 1, wherein unpacking data of the input data array based on the element size to generate unpacked data comprises:
receiving the input data array, the input data array comprising a plurality of elements, wherein a first element of the plurality of elements starts at a first bit of a vector representing the input data array;
extracting the plurality of elements into a plurality of lanes associated with the target format; and
positioning bits corresponding to each element of the plurality of elements in a respective lane of the plurality of lanes.

3. The method of claim 2, wherein unpacking the plurality of elements into the plurality of lanes associated with the target format comprises:
extracting consecutive elements of the plurality of elements into corresponding lanes of the plurality of lanes, wherein each of the extracted consecutive elements have the element size.

4. The method of claim 3, further comprising, after extracting consecutive elements of the plurality of elements into corresponding lanes of the plurality of lanes:
employing a value associated with the extracted consecutive elements of the plurality of elements into corresponding lanes of the plurality of lanes to index into a corresponding entry of a look up table (LUT).

5. The method of claim 2, wherein positioning bits containing each element of the input data array in one lane of the plurality of lanes comprises:
employing a shuffle input register to pick each lane of the plurality of lanes in which to position the bits.

6. The method of claim 2, wherein the converting further comprises:
shifting the unpacked data to one end of the respective lane of the plurality of lanes to generate shifted data; and
employing the shifted data to perform a look up table (LUT) operation with a LUT.

7. The method of claim 2, wherein each lane of the plurality of lanes comprises extra bits to convey encoding information for performing the converting to the output data array in the target format.

8. The method of claim 1, wherein the instruction further comprises reference to at least one look up table (LUT) to select a LUT for performing the converting, and wherein the LUT is programmable or has fixed contents.

9. The method of claim 1, wherein executing the one or more operations of the AI model with the output data array at the parallel processor comprises:
updating weights or activation functions of the AI model based on the output data array, or
performing inferencing based on the output data array.

10. The method of claim 1, wherein the initial format is a compressed format relative to the target format.

11. A method comprising:
accessing, by a parallel processor, an input data array in an initial format from a memory to execute one or more operations associated with an artificial intelligence (AI) model, wherein the input data array comprises a plurality of elements;
converting, at conversion circuitry of the parallel processor, the input data array into an output data array in a target format based on an instruction specifying an element size in the input data array, wherein the converting comprises:
creating a vector of indices based on the element size; and
unpacking data of the input data array into the vector of indices to generate unpacked data which is used with a look up table (LUT) to convert to the output data array in the target format; and
executing the one or more operations of the AI model with the output data array at the parallel processor.

12. The method of claim 11, wherein creating the vector of indices based on the element size comprises:
receiving the input data array, the input data array comprising a plurality of elements, wherein a first element of the plurality of elements starts at a first bit of a vector representing the input data array; and
creating the vector of indices based on vector representing the input data array and the element size.

13. The method of claim 11, wherein unpacking data of the input data array into the vector of indices to generate unpacked data comprises:
extracting each element of the plurality of elements into a respective index of the vector of indices; and
positioning bits of each extracted element in the respective index of the vector of indices to generate a value,
wherein the value corresponds to a corresponding entry in the LUT.

14. The method of claim 11, wherein each index of the vector of indices comprises extra bits to convey encoding information for performing the converting to the output data array in the target format, and wherein each index comprises extra bits for a zero extension or a sign extension.

15. The method of claim 11, wherein executing the one or more operations of the AI model with the output data array at the parallel processor comprises:
updating weights or activation functions of the AI model based on the output data array, or
performing inferencing based on the output data array.

16. A processing system comprising:
a processor to access an input data array comprising a plurality of elements in an initial format from a memory and convert the input data array into an output data array in a target format based on an instruction specifying an element size in the input data array, wherein the converting comprises:
creating a vector of indices based on the element size;
unpacking data of the input data array into the vector of indices to generate unpacked data; and
converting the unpacked data to the output data array in the target format; and
a plurality of compute units to execute operations of an artificial intelligence (AI) model with the output data array.

17. The processing system of claim 16, the processor further configured to:
receive the input data array, the input data array comprising a plurality of elements, wherein a first element of the plurality of elements starts at a first bit of a vector representing the input data array; and
create the vector of indices based on vector representing the input data array and the element size.

18. The processing system of claim 16, the processor further configured to:
extract each element of the plurality of elements into a respective index of the vector of indices; and
position bits of each extracted element in the respective index of the vector of indices to generate a value,
wherein the value corresponds to a corresponding entry in a look up table (LUT).

19. The processing system of claim 16, wherein each index of the vector of indices comprises extra bits to convey encoding information for performing the converting to the output data array in the target format.

20. The processing system of claim 16, wherein the initial format is a compressed format relative to the target format.
